(19) United States
(12) Patent Application Publication
(10) Pub. No.: US 2025/0230032 A1
(43) Pub. Date: Jul. 17, 2025

(54) Two Cycle Gas Can

(71) Applicant: Thomas Clary, Lancaster, KY (US)

(72) Inventor: Thomas Clary, Lancaster, KY (US)

(21) Appl. No.: 18/414,868

(22) Filed: Jan. 17, 2024

Related U.S. Application Data
(60) Provisional application No. 63/426,392, filed on Nov. 18, 2022.

(51) Int. Cl. B67D 7/22; B25H 3/02; B67D 7/00; B67D 7/04; B67D 7/38; G01F 19/00

(52) U.S. Cl. CPC B67D 7/22; B67D 7/005; B67D 7/04; B67D 7/38; B25H 3/02; G01F 19/00

(57) ABSTRACT

A specially designed two-cycle gas can which consists of a Forrest Green color two-cycle mixed gas and oil can that allows the user to immediately identify the contents of the gas can. The two-cycle gas can has a clear or translucent 1″ wide strip up and down the back of the can, with gradation of ¼, ½, ¾, and full marks. The two-cycle can also has a yellow slide pointer with gradations of 25 to 1, 32 to 1, 40 to 1, and 50 to 1 so the user always knows what mix is in the two-cycle can.

### CROSS-REFERENCE TO RELATED APPLICATIONS

This application claims benefit to provisional application U.S. 63/426,392 filed on Nov. 18, 2022 and is incorporated in its entirety.

### BACKGROUND OF THE INVENTION

The purpose of the present subject matter is to easily distinguish between a regular red gas can and the present subject matter, a forest green color 2 cycle mixed gas and oil can.

### SUMMARY OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. least one specification heading is required.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The present subject matter is an oil and gas can that is forest green in color and has some special features that make it convenient for the average homeowner or lawn service.

The present subject matter has a clear or translucent 1″ wide strip up and down the back of the can, with gradation of ¼, ½, ¾, and full marks. These gradations make it easy if you have ¼ in the can you can easily add exactly 1 gal to mix with without guesswork.

Furthermore, the present subject matter on top near the handle has a yellow slide pointer with gradations of 25 to 1, 32 to 1, 40 to 1, and 50 to 1 so the user always knows what mix is in the can. Also embossed on the side is a chart of how much oil to gas ratios which allows the user to always know how much oil to ad per gallon.

In some embodiments, the container will be 1½ gallons and forest green in color. A flexible filler hose with a trigger mechanism for ease of control of fuel flow to prevent overspilling the smaller fuel tanks.

In some embodiments, the fill cap will have a plastic strainer to keep debris or trash from entering the can. The container also has a built-in toolbox with plastic closure for bottles of 2-cycle mix oil and for equipment, small tools, and things like weed-eater line, spark plugs, wrenches, screw drivers, pliers, etc.

In some embodiments, hook and loop labels are used to designate what mix is inside the can. These labels are attached to the tool caddy when not in use.

In some embodiments, the trigger hose unscrews when not in use and the securing cap seals the can. This will fit in the tool caddy. Velcro is used under labels and the other side will attach in tool area to stay clean. The mix in the can label of choice will attach near the filler cap. While several illustrative embodiments of the invention have been shown and

described, numerous variations and alternative embodiments will occur to those skilled in the art. Such variations and alternative embodiments are contemplated and can be made without departing from the scope of the invention as defined in the appended claims.

### BRIEF DESCRIPTION OF DRAWINGS

FIG. 1 shows a top view of the two cycle gas can.

FIG. 2 shows a cutaway view of the two cycle gas can.

FIG. 3 shows a side view of the two cycle gas can.

FIG. 4 shows a side view of the two cycle gas can.

FIG. 5 shows a front view of the two cycle gas can.

FIG. 6 shows a back view of the two cycle gas can.

FIG. 7 shows a side view of the two cycle gas can.

FIG. 8 shows a side view of the two cycle gas can.

FIG. 9 shows a back perspective view of the two cycle gas can.

FIG. 10 shows a front perspective view of the two cycle gas can.

### DETAILED DESCRIPTION OF THE INVENTION

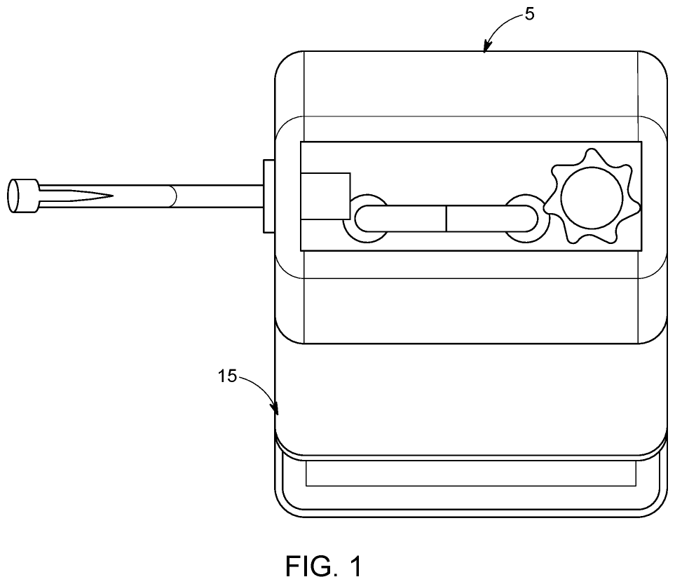

FIG. 1 shows a top view of the two cycle gas can wherein the outer thickness width of the two cycle can is 10.02 inches, the elevated inner thickness width of the two cycle can is 6.31 inches, and the width of the top of the two cycle can is 3.43 inches. The length of the two cycle can is 8.41 inches.

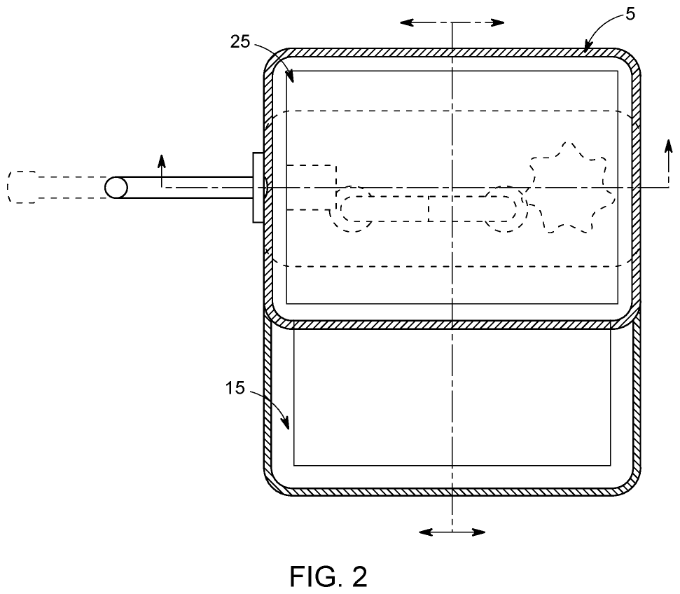

FIG. 2 shows a cutaway view of the two cycle gas can wherein the two cycle can has a fuel chamber 25 for two cycle fuel and an attached lower tool box 30 to hold tools or containers of oil for mixing with fuel.

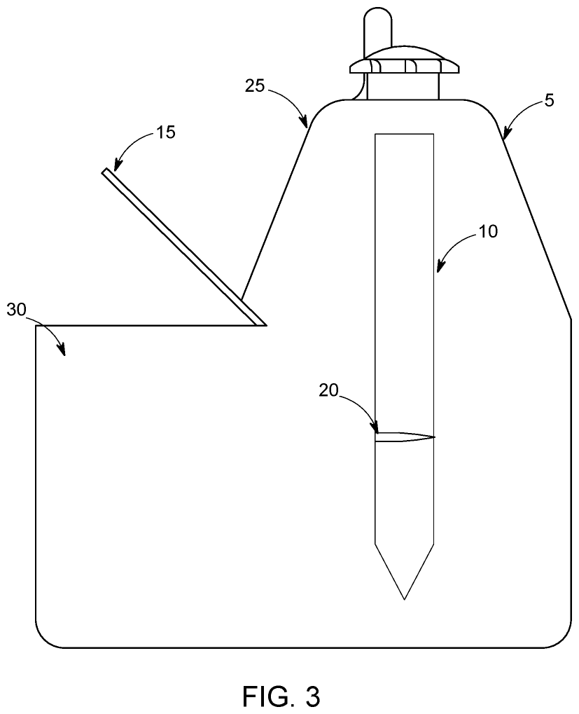

FIG. 3 shows a side view of the two cycle gas can wherein the overall height of the two cycle gas can is 10.20 inches, wherein the lower tool box 30 is 6.12 inches and the fuel chamber 25 is 4.08 inches tall. The length of the lower tool box lid is 4.27 inches. The thickness of the lower tool box lid is .04 inches.

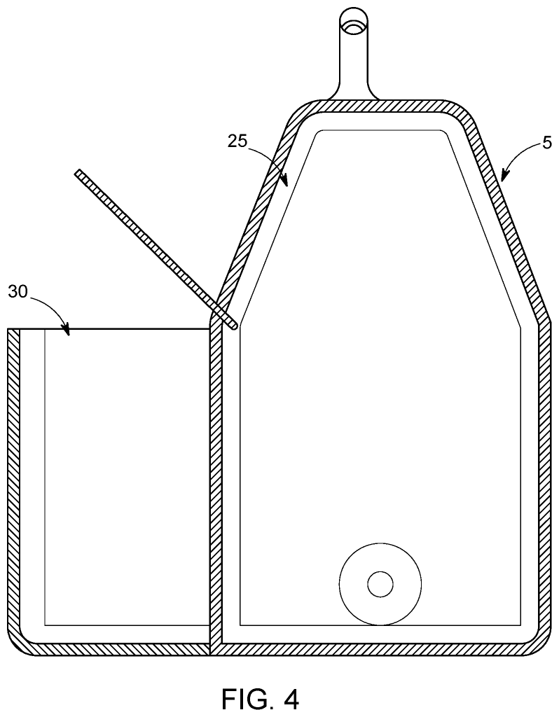

FIG. 4 shows a side view of the two cycle gas can wherein the lower tool box 30 is designed to hold tools or oil containers for mixing, and the fuel chamber 25 is designed to hold 1.5 gallons of two cycle gas.

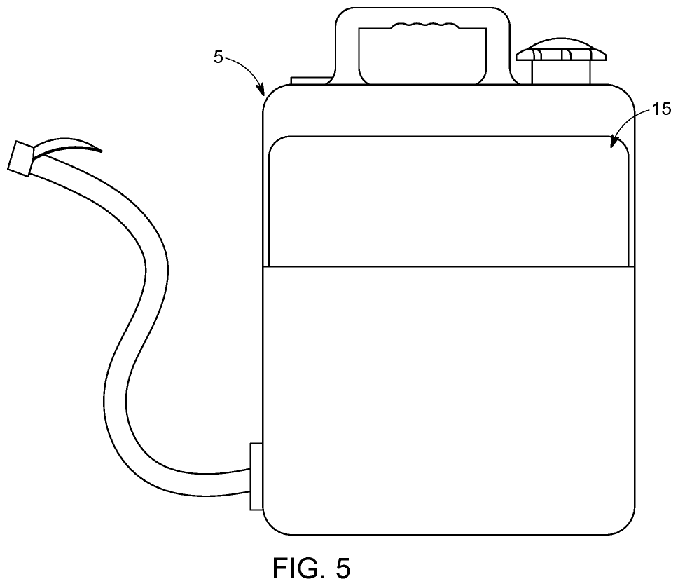

FIG. 5 shows a front view of the two cycle gas can wherein the release nozzle is 1.76 inches in length, the height of the lower tool box 30 is 6.12 inches and the height of the fuel chamber is 4.08 inches for a total height of 10.20 inches. The length of the handle is 3.9 inches. The inner diameter of the screw on cap is 1.32 inches and the outer diameter of the screw on cap is 2.07.

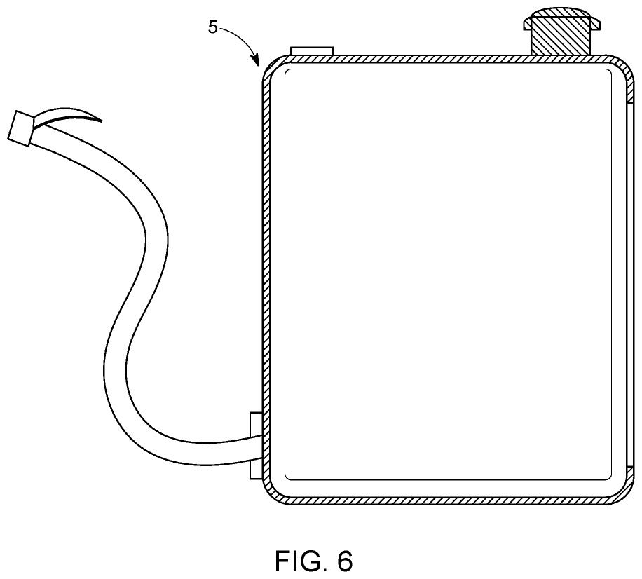

FIG. 6 shows a back view of the two cycle gas can wherein the fuel chamber 25 holds 1.5 gallons.

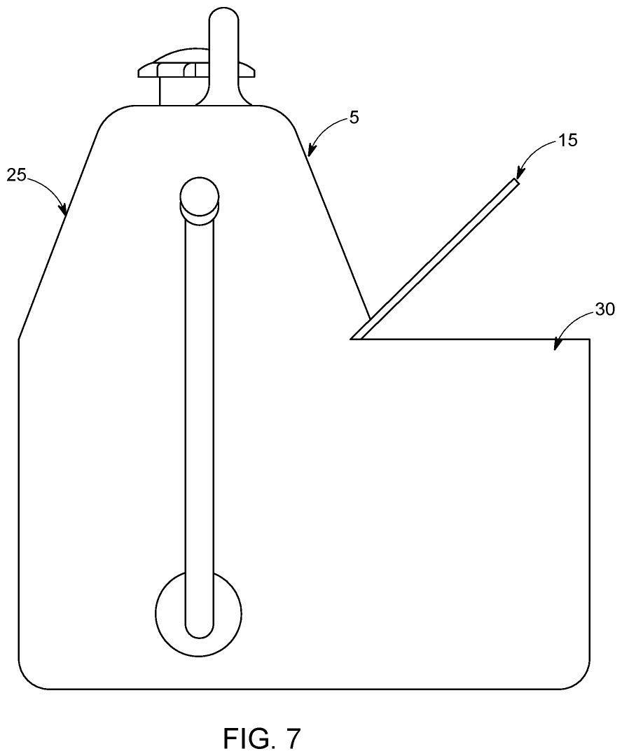

FIG. 7 shows a side view of the two cycle gas can wherein the hose is 11 inches long when fully extended. The diameter of the hose connector is 1.5 inches. The width of the handle is .5 inches and the height of the handle is 1.75 inches.

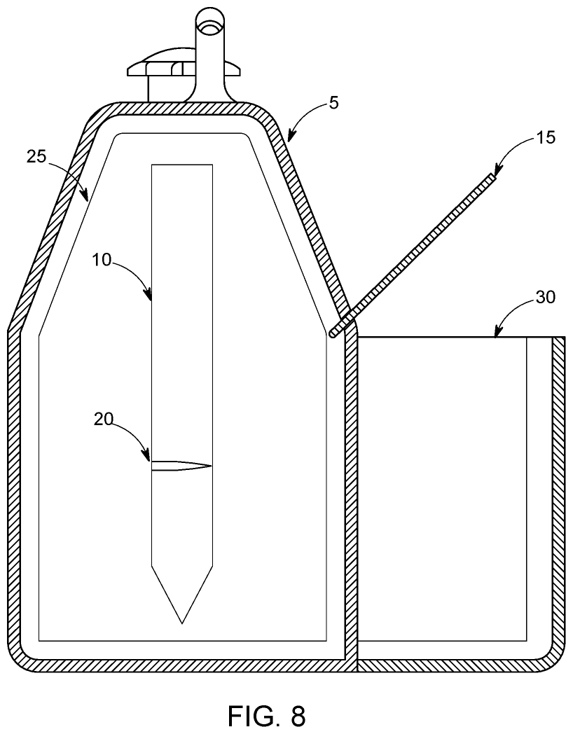

FIG. 8 shows a side cutaway view of the two cycle gas can wherein the fuel chamber 25 and the lower tool box 30 are two separate chambers.

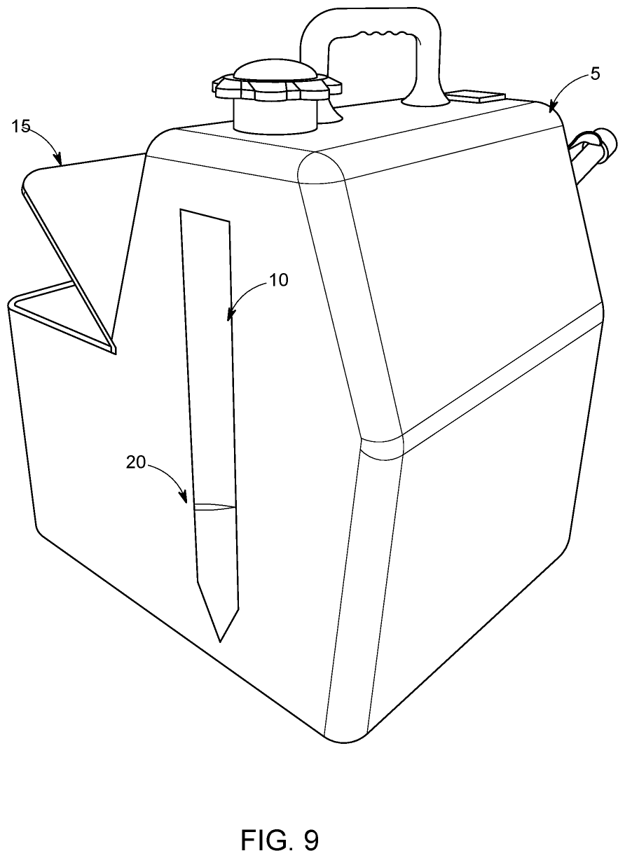

FIG. 9 shows a back perspective view of the two cycle gas can wherein the forest green surface 5 alerts the user the fuel inside is a mixture of gasoline and oil. The transparent measuring window 10 allows for the user to determine the amount of fuel inside the can and the amount of oil that must be added. A yellow slider 20 points is able to point to mixing ratios 1:1, 2:1, 3:1, 4:1, 5:1, 10:1, 20:1, 25:1, 32:1, 40:1, and 50:1.

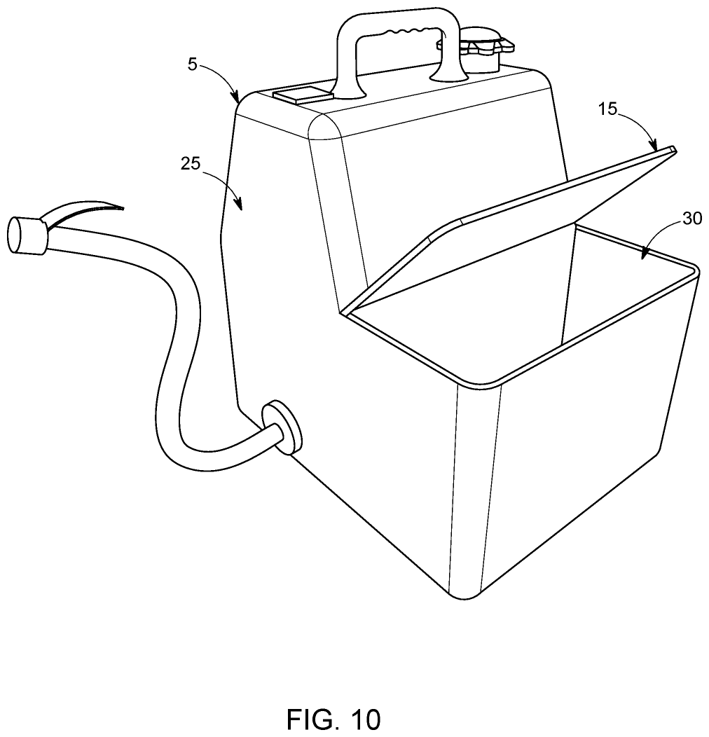

FIG. 10 shows a front perspective view of the two cycle gas can wherein the forest green surface 5 alerts the user the fuel inside is a mixture of gasoline and oil. The lower tool box lid 15 allows for easy storage of tools and containers of oil meant for mixing with fuel.

1. A forest green two-cycle mixed gas and oil can comprising of:
a) A fuel chamber;
b) A hose and nozzle to dispense two cycle fuel;
c) A lower tool box with a lid;
d) A screw on top;
e) A handle;
f) A translucent 1″ wide stripe up and down the back of the can;
g) A gradation of ¼, ½, ¾, and full marks;
h) A yellow slide pointer with ratios ranging from 1:1 to 50:1; and
i) An embossed chart with instructions with regard to oil to gas ratios.

2. The forest green two-cycle mixed gas and oil can as in claim 1, wherein the translucent 1″ wide strip allows the user to accurately measure the amount of fuel in the container.

3. The translucent 1″ wide strip as in claim 1, wherein the gradation on the indicates when the container is ¼, ½, and ¾ full.

4. The yellow slide pointer with ratios ranging from 1:1 to 50:1 as in claim 1, wherein the ratios include 1:1, 2:1, 3:1, 4:1, 5:1, 10:1, 20:1, 25:1, 32:1, 40:1, and 50:1.

5. The forest green two-cycle mixed gas and oil can as in claim 1, wherein the lower tool box is designed to hold tools or containers of oil for mixing into the fuel chamber.
